(19) United States
(12) Patent Application Publication
(10) Pub. No.: US 2009/0052818 A1
(43) Pub. Date: Feb. 26, 2009

(54) Hybrid bearing

(76) Inventor: Jason Matthew Mitmesser, Jeffersonville, IN (US)

Correspondence Address: Jason Mitmesser, 5279 Sanibel Vista, Jeffersonville, IN, 47130, US

(21) Appl. No.: 12/217,983

(22) Filed: Jul. 10, 2008

Related U.S. Application Data
(60) Provisional application No. 60/958,998, filed on Jul. 10, 2007.

(51) Int. Cl. F16C 32/06; F16C 17/04

(52) U.S. Cl. 384/121; 384/420

(57) ABSTRACT

One embodiment of a hybrid vertical axis rotating load carrying bearing with continuously variable operating conditions able to carry surprisingly heavy weight, and occasionally easily able to carry drastically more weight than that; The preferred embodiment has 3 different types of bearings combined to form one ideal bearing. The first type of bearing is a half ball and female sliding bearing. The second type of bearing is a floating bearing that surrounds the sliding bearing. The third type of bearing is rolling bearings. In this preferred embodiment with 3 different types of bearings, the rolling bearings are partially engaged under ideal load weight conditions, and nearly fully engaged under severe load weight conditions. The sliding and floating bearings are always fully engaged into the vertical weight load no matter what the vertical weight load may be.

Another embodiment is the hybrid bearing containing two types of bearings; a floating bearing and rolling bearings. In this embodiment, a floating bearing is in the center axis and rolling bearings are located outside the floating bearing, on a larger diameter circle. In ideal operating conditions, the floating bearing will hold nearly all the load, and some of the rolling bearings will engage into the rotating load. In severe conditions, nearly all rolling bearings will engage into the rotating load.

This application claims the benefits of provisional patent 60/958,998, filing receipt confirmation number 8417, filed Jul. 10, 2008.

### BACKGROUND OF THE INVENTION

1. Prior Art

None.

2. Objects and Advantages
A) To provide a heavy object with a bearing enabling it to rotate without wearing out the bearing for a long time.

### SUMMARY

In accordance with the present invention a hybrid bearing that can carry a varying weight load that has potential to be very heavy.

What is claimed is:

1) A hybrid bearing.

2) A bearing in claim 1 with at least 2 different types of bearings combined to form one ideal bearing.

3) said hybrid bearing in claim 1 comprised of a floating bearing resting in a water pool with said floating bearing containing a lightweight inside framework for structural support and sealer on outside and inside of said floating bearing.

4) said hybrid bearing in claim 1 also comprised of a socket and ball upper and lower die sliding bearing with outflow channels and a lubricating coolant filtered and sent through said outflow channels during operation; said socket and ball dies supported underneath by a Sliding Bearing Support Structure, resting in center of said pool of water and surrounded by said floating bearing.

5) said hybrid bearing also comprised of wheeled bearings; said wheeled bearings to be comprised of several different types, with different diameter sizes;

6) some of said wheeled bearings equipped with self-propelling motors, to be positioned under said central tower of said wind turbine; said motorized wheeled bearings to engage into central axis tower under one bearing operating condition, and to disengage from central axis tower under another bearing operating condition.

7) An alternate embodiment of the hybrid bearing is to be a floating bearing with wheel bearings on outside of floating section.

### DRAWINGS

FIG. A:
1) Concrete Foundation
2) Floating bearing
3) Floating bearing
4) Sliding bearing support structure
5) Lower die
6) Upper die
7) Concrete foundation
8) Water
9) Track where wheel bearing rests

FIG. B ^{nd} alternate embodiment
16) Floating bearing
17) concrete foundation
18) water
19) concrete foundation
20) track

FIG. G Sliding bearing
1) tower
2) lower die
3) upper die rotating (show it is pulled apart from lower die)
4) oil filter and pump
5) oil filter and pump
6) oil pipe
7) hole where oil is pumped at high pressure
8) additional hole where oil is pumped
9) oil filter and pump

FIG. H
1˜8) sections where upper die rests on lower die
9˜17) outflow channel sections where oil flows onto the die and then down into the oil pool
18) holes where oil flows out onto the die.

FIG. I Closeup of FIG. G #8 hole
1) upper die
2) lower die
3) hole where oil flows
4) outflow channel
5) outflow channel

FIG. J Side view closeup of an outflow channel
1) lower die
2) upper die
3) outflow channel where oil flows

### DRAWINGS

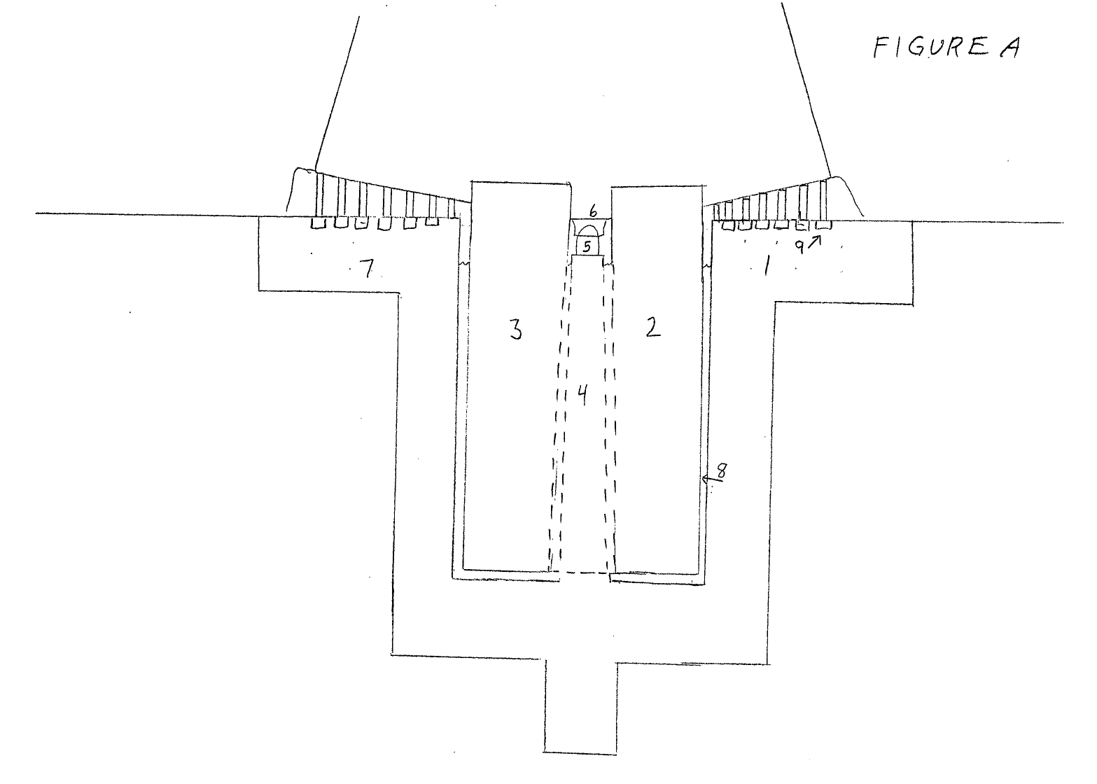

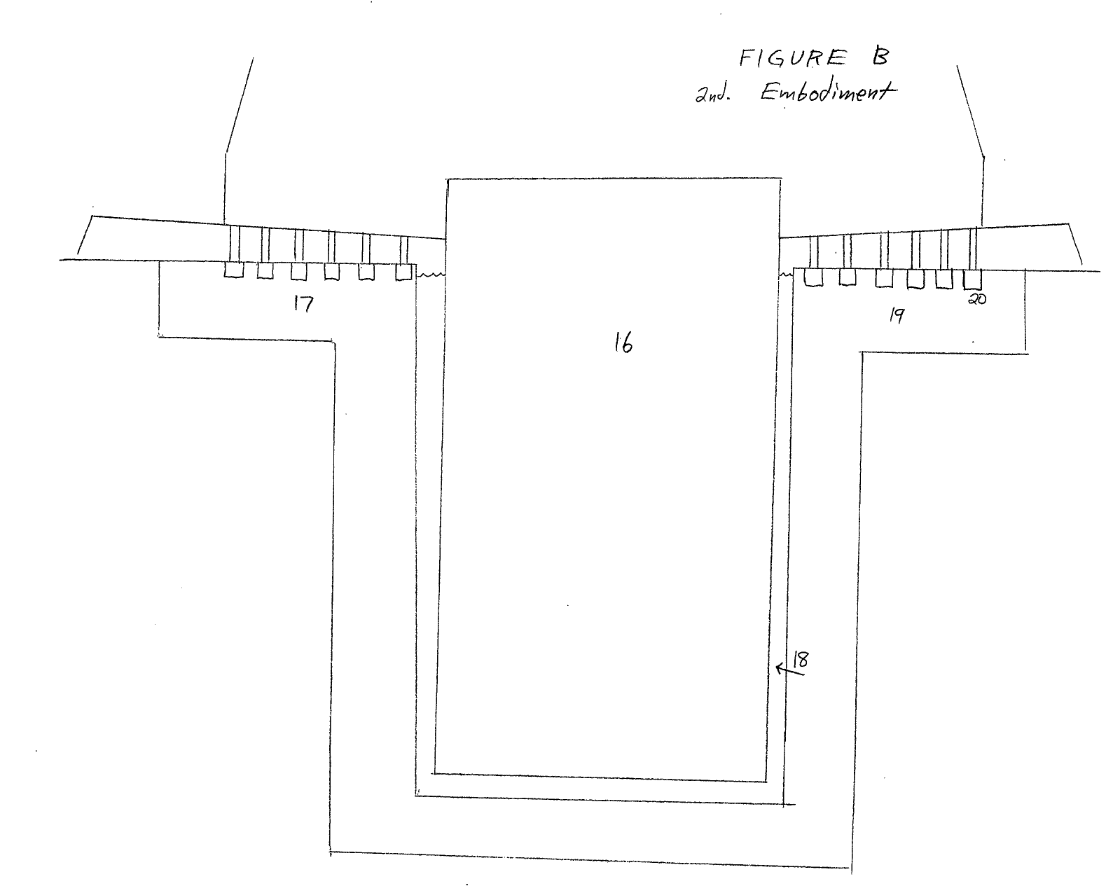

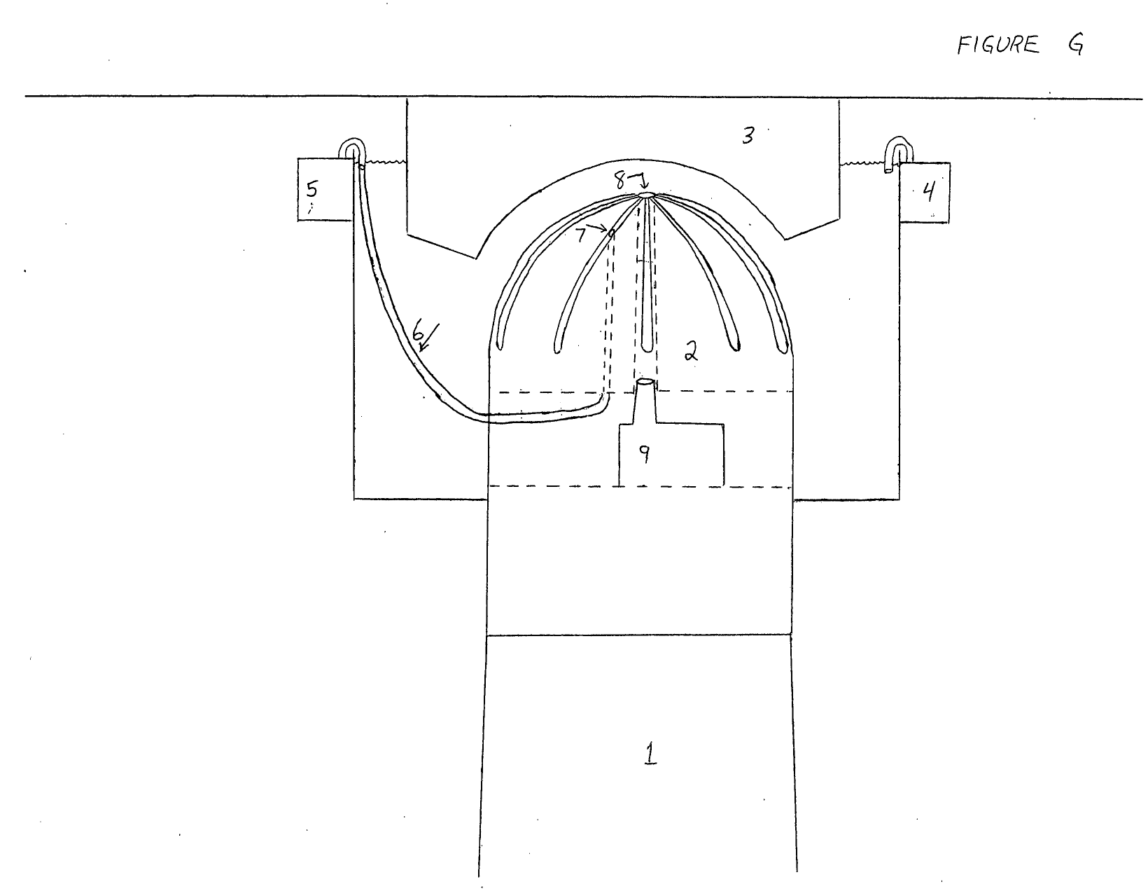

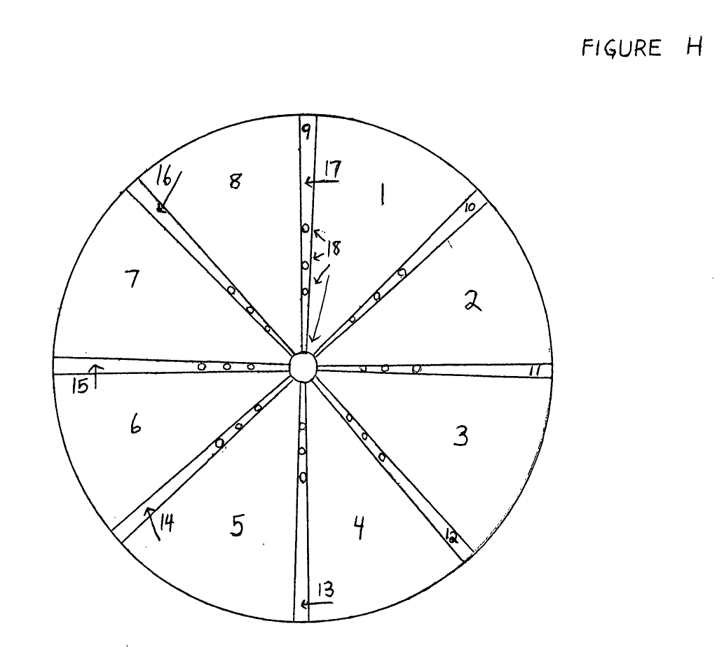

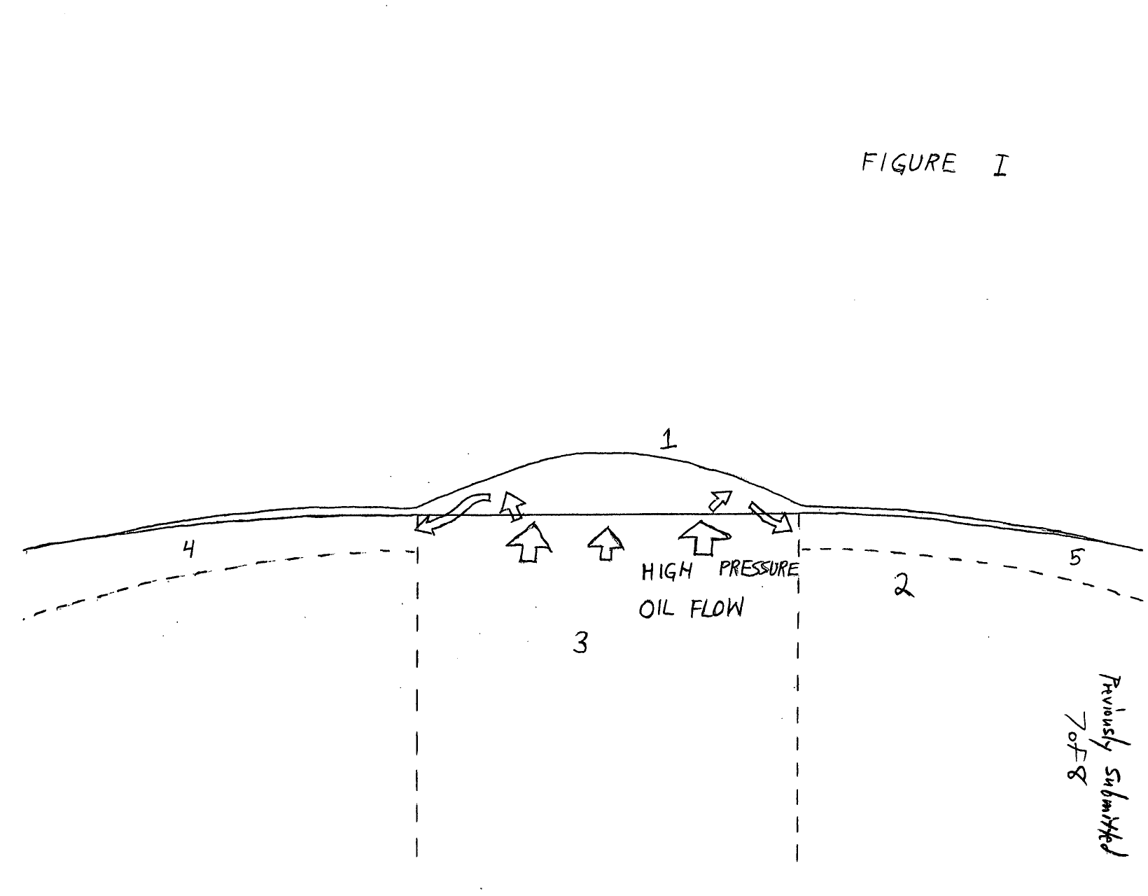

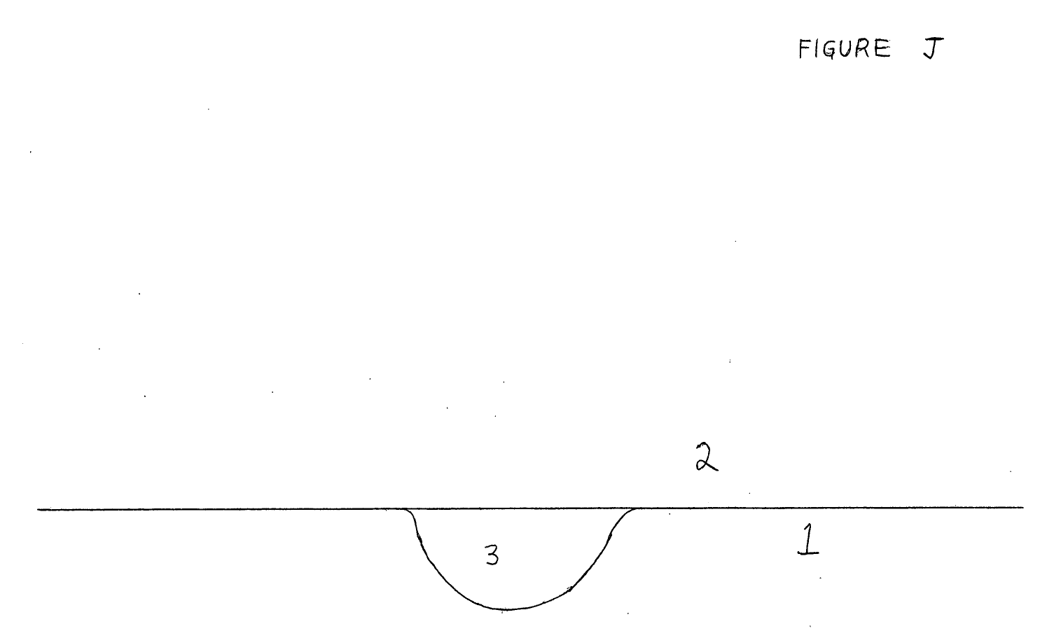

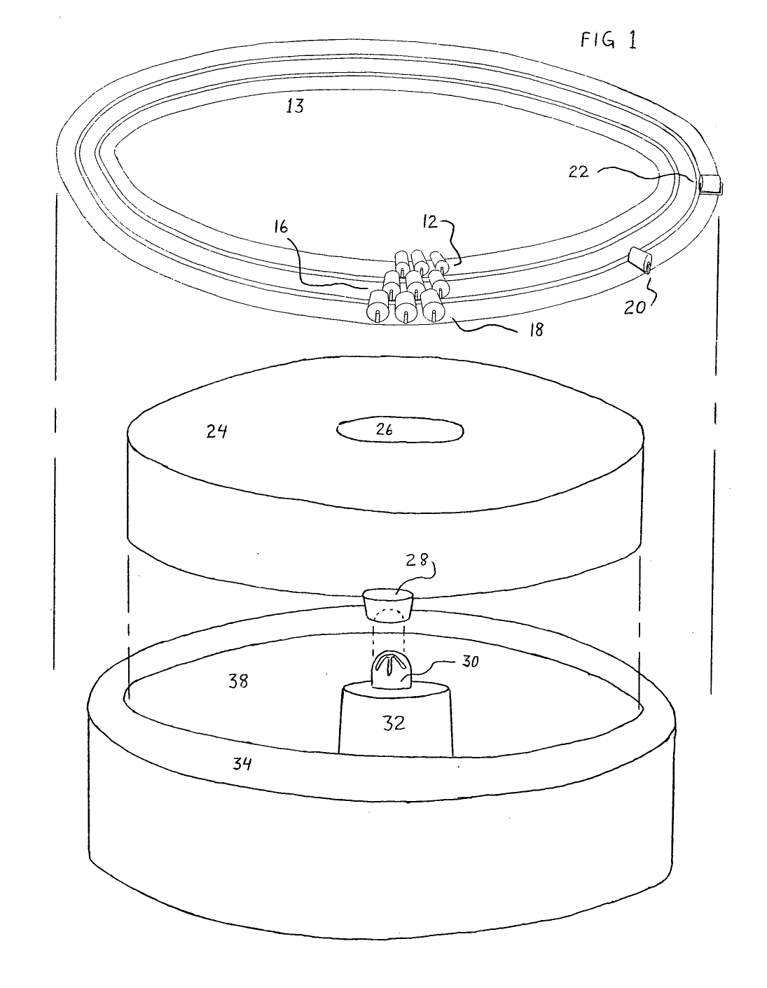

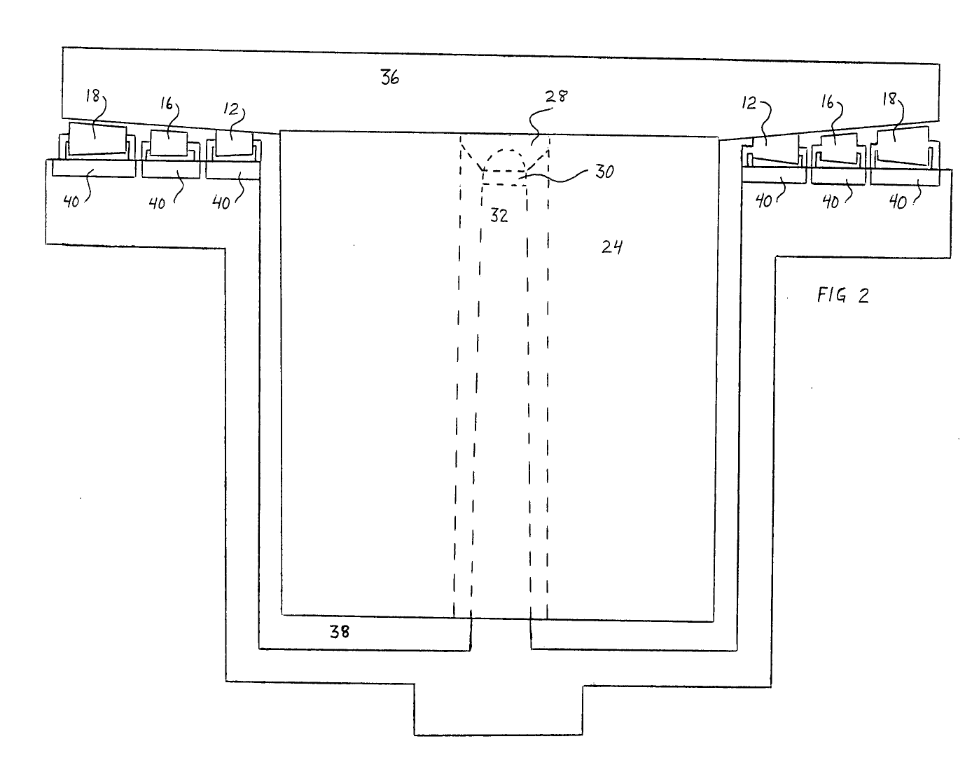

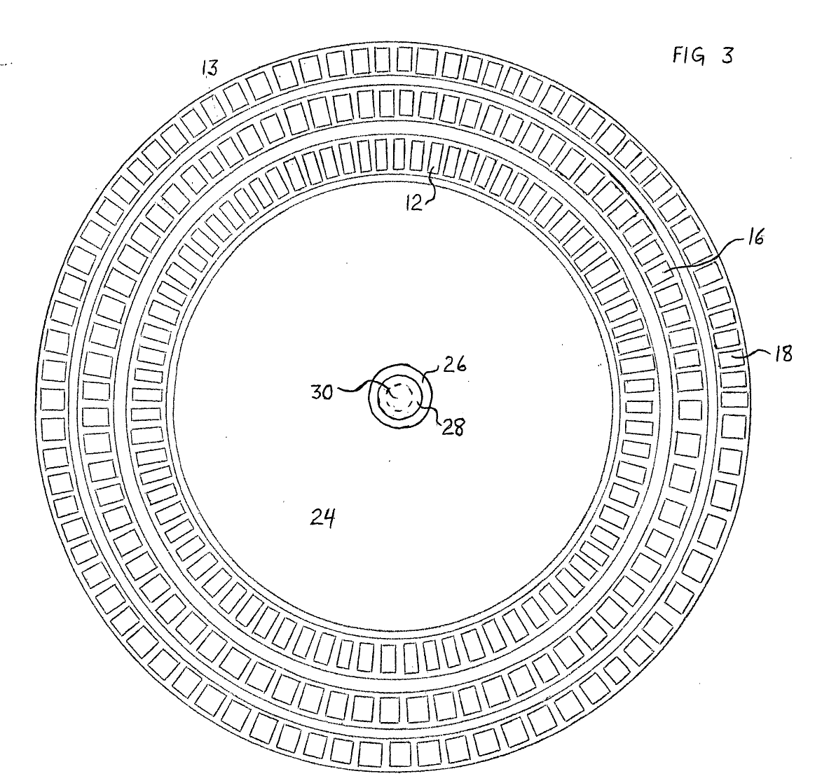

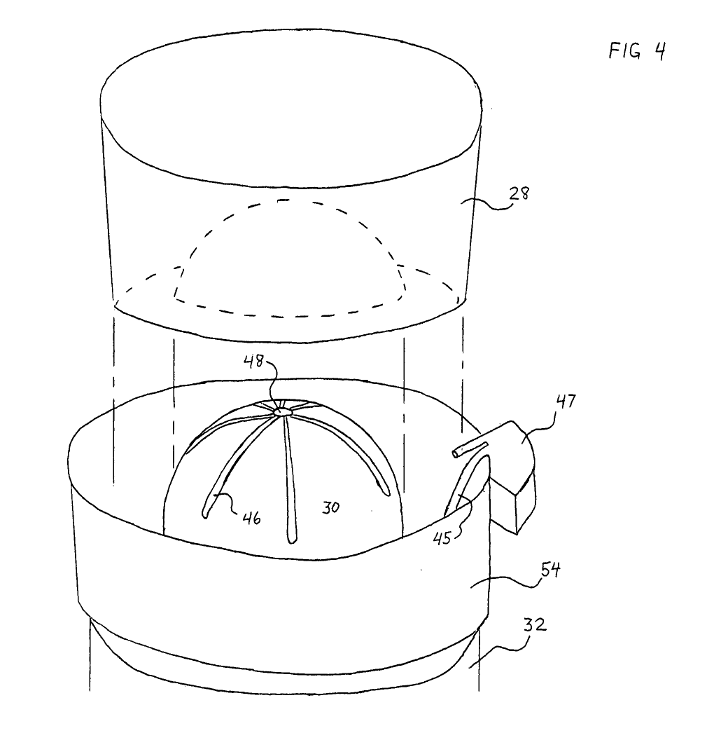

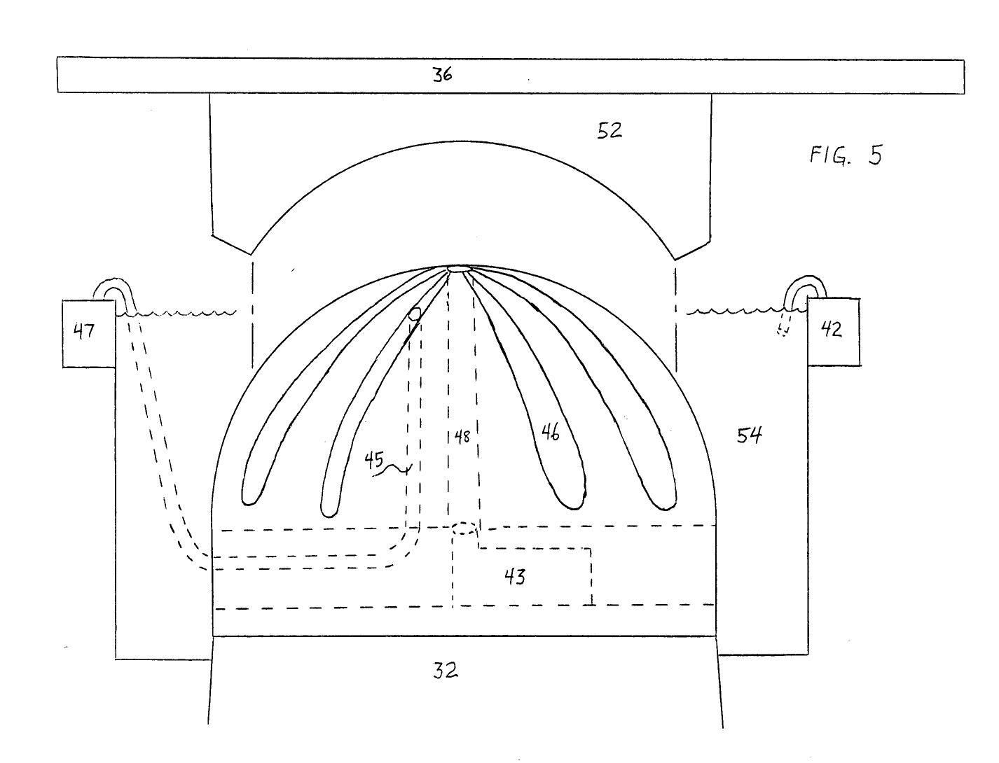

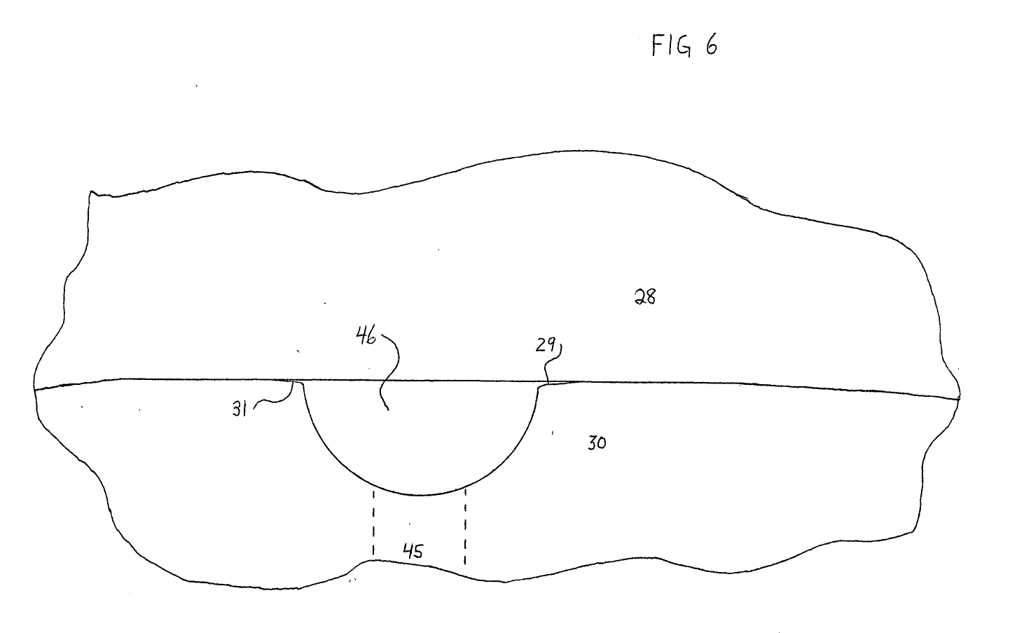

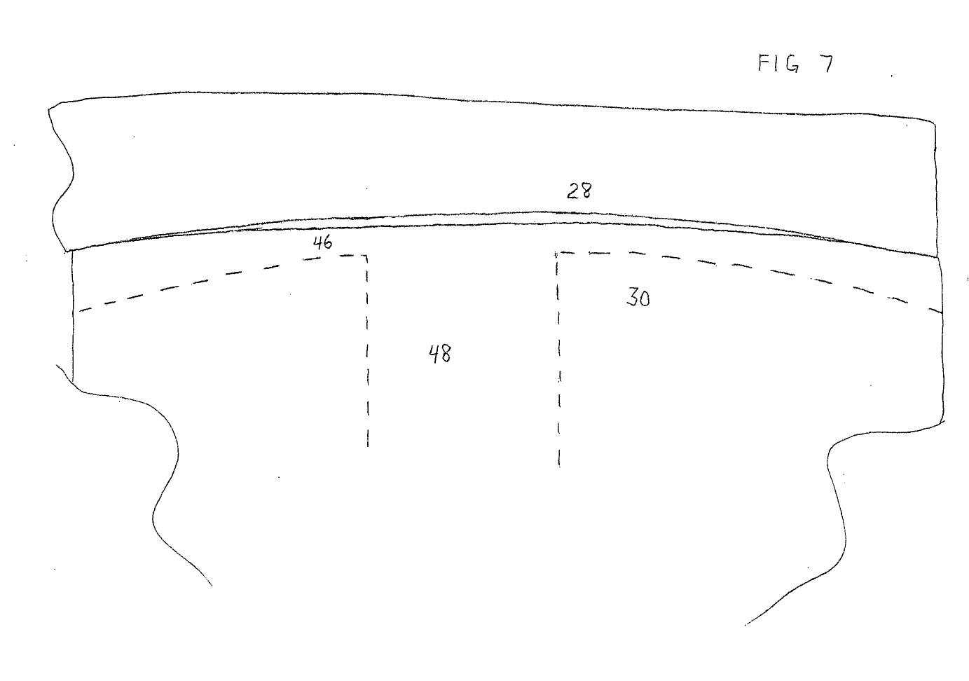

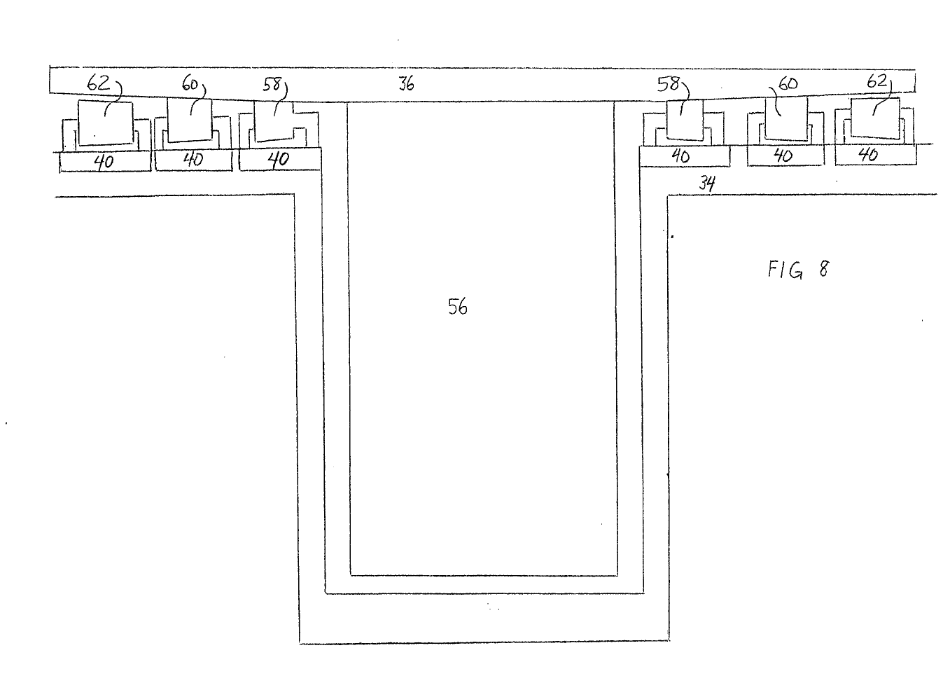

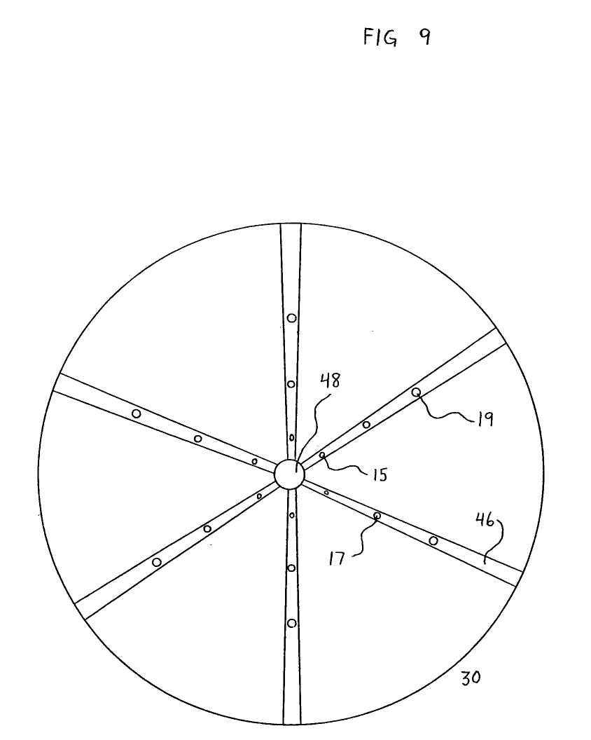

Previously submitted drawings did not have proper margins, and they also contained interlineations. Applicant wishes to replace FIG. A, FIG. B 2^{nd} alternate embodiment, FIG. G, FIG. H, FIG. I, and FIG. J with new drawings below; FIG. 1, FIG. 2, FIG. 3, FIG. 4, FIG. 5, FIG. 6, FIG. 7, FIG. 8 and FIG. 9. There is no new matter in the new drawings. The new drawings FIG. 1˜9 have proper margins, and have been improved to show more isometric views that are easier to visualize and should be allowable, as it is the applicant's response to the rejected drawings.

DRAWINGS:

FIG. 1 An exploded isometric perspective of the entire hybrid bearing. In between Reference Numbers 28 and 30 there are additional explosion lines, indicating 28 fits on top of 30. 24 fits inside of 34, and 24 is evenly surrounding 32, with 30 and 28 protruding. 13 fits on top of 34, and also has a larger diameter than 34.
12) Rolling Bearing (inside track)
13) Entire plurality of rolling bearings
16) Rolling Bearing (middle track)
18) Rolling Bearing (outside track)
20) A single Rolling Bearing with a different position
22) A single Rolling Bearing with another different position
24) Floating Bearing
26) Hole in central axis of floating bearing
28) Female Die
30) Half Ball Die
32) Ball Die Support Structure
34) Water Pool wall (also serves as partial foundation for rolling bearings)
38) Inside of the water pool

FIG. 2 Section view, side perspective of the entire hybrid bearing in optimal operating condition
12) Rolling Bearing engaged into the vertical axis rotating load (inside track)
16) Rolling Bearing not yet engaged into the vertical axis rotating load (middle track)
18) Rolling Bearing not yet engaged into the vertical axis rotating load (outside track)
24) Floating Bearing
28) Female Die
30) Half Ball Die
32) Half Ball Die Support Structure
34) Water Pool wall (also serves as partial foundation for rolling bearings)
36) Verticle Axis Rotating Load
38) Inside of the water pool
40) Rolling Bearing engagement device

FIG. 3 Section view, top perspective of the hybrid bearing
12) Rolling Bearing (inside track)
16) Rolling Bearing (middle track)
18) Rolling Bearing (outside track)
24) Floating Bearing
26) Hole in central axis of floating bearing
28) Female Die
30) Half Ball Die

FIG. 4 An exploded isometric perspective of the sliding bearing
28) Female Die
30) Half Ball Die
32) Half Ball Die Support Structure
47) Filter and high power pump unit
45) Coolant post filter and pump outflow tube
46) Half Ball Die Downflow Channel
48) Half Ball Die Coolant upflow opening (at exact center of entire hybrid bearing)
54) Lubricant Container

FIG. 5 Slightly exploded side perspective view of the sliding bearing's half ball die and the female die if it were cut in half through the center and raised above the half ball die.
32) Half Ball Die Support Structure
36) Verticle Axis Rotating Load
42) Filter and high power pump unit
43) Pump and filter unit
45) Lubricant Post Filter and pump outflow tube
46) Down flow channel
47) Filter and pump
48) Half Ball Die lubricant upflow channel
52) Female Die (rotating when bearing is in operation)
54) Lubricant Container

FIG. 6 Closeup of a cutaway section of the sliding bearing's half ball die downflow channel.
28) Female Die
29) Tapered Shape to die formation (right side of downflow channel)
30) Half Ball Die
31) Tapered Shape to die formation (left side of downflow channel)
45) Lubricant Post Filter and pump outflow tube
46) Half Ball Die Downflow Channel

FIG. 7 Close up of a side perspective of the sliding bearing's top and central section
28) Female Die
30) Half Ball Die
46) Half Ball Die Downflow Channel
48) Half Ball Die Coolant upflow opening (at exact center of entire hybrid bearing)

FIG. 8 Alternative Embodiment of the invention—a floating and rolling bearings only
34) Water Pool wall (also serves as partial foundation for rolling bearings)
36) Vertical Axis Rotating Load
40) Rolling Bearing lifting/lowering device
56) Floating bearing
58) Rolling Bearing that is engaged into the load (inside track)
60) Rolling Bearing that is engaged into the load (middle track)
62) Rolling Bearing that is not engaged into the load (outside track)

FIG. 9 Top section view of the half ball die
15) Upper Hole where lubricant is pumped upward with high pressure to hit female die (this is a top section view of 45 Lubricant Post Filter and pump outflow tube).
17) Middle Hole where lubricant is pumped upward with high pressure to hit female die (this is a top section view of 45 Lubricant Post Filter and pump outflow tube).
19) Lower Hole where lubricant is pumped upward with high pressure to hit female die (this is a top section view of 45 Lubricant Post Filter and pump outflow tube).
30) Half Ball Die
46) Half Ball Die Downflow Channel
48) Half Ball Die Lubricant upflow opening (at exact center of entire hybrid bearing)

1-7. (canceled)

8) A bearing with at least 2 different types of bearings combined to form one ideal hybrid bearing whereby it is able to support a vertical axis rotating heavy object with continuously varying weight.

9) said hybrid bearing in claim 8 partially comprised of a floating bearing resting in a water pool.

10) said hybrid bearing in claim 8 partially comprised of a sliding bearing located at the central axis position of the entire hybrid bearing.

11) Said hybrid bearing in claim 8 is also comprised of one to a substantial number of rolling bearings.

12) Said sliding bearing in claim 10 containing a stationary half ball die support structure underneath a half ball die.

13) Said sliding bearing in claim 10 containing a female die that rests upon said half ball die in claim 12.

14) Said female die in claim 13 is adjoined to a vertical axis rotating load that the hybrid bearing is supporting.

15) Said half ball die in claim 12 containing one to a substantial number of upflow and downflow channels whereby a lubricating coolant is sent in between said half ball die and said female die in claim 13 during rotation of the bearing.

16) Said floating bearing in claim 9 surrounding said half ball die support structure in claim 12.

17) Said floating bearing in claim 9 is attached to and below said vertical axis rotating load in claim 14.

18) Said rolling bearings in claim 11 to be positioned in a plurality of one to several circular ring layers surrounding said floating bearing in claim 9.

19) Said rolling bearings in claim 11 to each contain a lifting device underneath it that can raise each individual rolling bearing and lower each individual rolling bearing to engage and disengage the rolling bearings into said vertical axis rotating load in claim 14.

20) Said Ball die in claim 10 to contain one to a substantial number of coolant filters.

21) Ball die in claim 10 to contain a high pressure pump, distributing coolant vertically up the said upflow channel in claim 14, and then down the downflow channel into a large coolant reservoir and back into circulation.

22) Said rolling bearings in claim 11 to be partially engaged into vertical rotating load under ideal conditions.

23) Said rolling bearings in claim 11 to be nearly fully engaged into vertical rotating load under severe conditions.

24) Under ideal conditions such as dry weather with no precipitation adhering to vertical axis rotating object, said sliding bearing in claim 12, Said floating bearing in claim 9, and a small number of said rolling bearings in claim 11, all combine to support the vertical axis rotating load.

25) Under more severe operating conditions than the operating conditions in claim 24, more rolling bearings in claim 11 are engaged into the vertical axis rotating load.

26) Under the most severe operating conditions such as a major freezing rain ice storm, nearly all rolling bearings in claim 11 engage into the vertical axis rotating load.

27) An alternate embodiment of the hybrid bearing is to be a floating bearing as the central axis with rolling bearings located a further distance away from the central axis.
